(19) United States
(12) Patent Application Publication
(10) Pub. No.: US 2020/0298865 A1
(43) Pub. Date: Sep. 24, 2020

(54) Vehicle Environmental Controlling

(71) Applicant: Bose Corporation, Framingham, MA (US)

(72) Inventors: Davis Y. Pan, Arlington, MA (US); David S. Andreasen, Boston, MA (US)

(73) Assignees: Bose Corporation, Framingham, MA (US); Bose Corporation, Framingham, MA (US)

(21) Appl. No.: 16/823,700

(22) Filed: Mar. 19, 2020

Related U.S. Application Data
(60) Provisional application No. 62/821,384, filed on Mar. 20, 2019.

(51) Int. Cl. B60W 40/09; B60W 50/00; G06K 9/00; B60H 1/00; B60R 11/04

(52) U.S. Cl. CPC B60W 40/09; B60W 50/0098; G06K 9/00845; B60W 2040/0872; B60H 1/00764; B60H 1/00757; B60R 11/04; B60H 1/00742

(57) ABSTRACT

Systems and methods for controlling an environment of a vehicle receive information about a characteristic of at least one of the vehicle's operation, the vehicle's location, and an operator of the vehicle. The information is analyzed to assess a driving condition. An environmental setting of the vehicle is adjusted based upon the assessed driving condition.

### CROSS REFERENCE TO RELATED APPLICATIONS

This application claims priority under 35 USC § 119(e) to U.S. Provisional Patent Application Ser. No. 62/821,384, titled “VEHICLE ENVIRONMENTAL CONTROLLING” filed Mar. 20, 2019, which is incorporated herein in its entirety for all purposes.

### BACKGROUND

Driving while sad, angry, or upset may increase the chances of an accident by nearly a factor of ten, which is even riskier than handheld texting while driving. Driving while fatigued or drowsy may increase the chances of an accident by a factor of more than three. Further, aggressive driving significantly increases the chances of an accident, on par with driving under the influence of drugs or alcohol. Accordingly, there is a need for systems and methods to influence an operator of a vehicle to drive in a calm and vigilant manner.

### SUMMARY

Systems and methods disclosed herein are directed to audio systems, methods, and applications that control or adjust environmental conditions, such as lighting, temperature, and audio, in the cabin of a vehicle, such as an automobile or truck. The systems, methods, and applications adjust the environment in response to detecting an operator's vigilance, driving style, and/or mood, such that the environmental changes may influence the operator to drive in a calm and vigilant manner.

According to one aspect, a method of controlling an environment of a vehicle is provided that includes receiving information about a characteristic of at least one of the vehicle's operation, the vehicle's location, and an operator of the vehicle, analyzing the information using a generalized additive model to assess a driving condition, and adjusting an environmental setting of the vehicle based upon the assessed driving condition.

According to some examples, information about a characteristic of the vehicle's operation may include one or more of speed, braking, and steering.

In various examples, information about a characteristic of the operator of the vehicle may include biological information from a sensor. The biological information may include one or more of heart rate, temperature, respiration rate, and blood pressure.

Certain examples may include receiving and processing image information from a camera. Processing image information may include determining the information about a characteristic of the operator.

In some examples, the information about a characteristic of the operator may include one or more of heart rate, temperature, respiration rate, look direction, blink rate, and blood pressure.

In certain examples, assessing a driving condition includes assessing at least one of a driving style of the operator, vigilance of the operator, and an emotional state of the operator.

According to various examples, the environmental setting may include one or more of an audio volume, an audio content, an audio perception, a temperature setting, a lighting brightness, a lighting color temperature, an air conditioning setting, and a humidity control.

According to another aspect, a vehicle is provided that includes a plurality of sensors for detecting information about a characteristic of at least one of the vehicle's operation, the vehicle's location, and an operator of the vehicle, a controller coupled to the plurality of sensors and configured to receive and analyze the information using a generalized additive model to assess a driving condition, and one or more environmental controls coupled to the controller, the controller further configured to adjust an environmental setting of the vehicle based upon the assessed driving condition.

In certain examples, information about a characteristic of the vehicle's operation includes one or more of speed, braking, and steering.

In some examples, information about a characteristic of the operator of the vehicle includes biological information from a sensor. The biological information may include one or more of heart rate, temperature, respiration rate, and blood pressure.

According to various examples, the controller may be further configured to receive and process image information from a camera. The controller may process the image information to determine the characteristic of the operator.

In various examples, the information about a characteristic of the operator may include one or more of heart rate, temperature, respiration rate, look direction, blink rate, and blood pressure.

In certain examples, assessing a driving condition includes assessing at least one of a driving style of the operator, vigilance of the operator, and an emotional state of the operator.

In various examples, the environmental setting may include one or more of an audio volume, an audio content, an audio perception, a temperature setting, a lighting brightness, a lighting color temperature, an air conditioning setting, and a humidity control.

Still other aspects, examples, and advantages of these exemplary aspects and examples are discussed in detail below. Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

### BRIEF DESCRIPTION OF THE DRAWINGS

Various aspects of at least one example are discussed below with reference to the accompanying FIGURES, which are not intended to be drawn to scale. The figures are included to provide illustration and a further understanding of the various aspects and examples, and are incorporated in and constitute a part of this specification, but are not intended as a definition of the limits of the inventions. In the FIGURES, identical or nearly identical components illustrated in various FIGURES may be represented by a like reference character or numeral. For purposes of clarity, not every component may be labeled in every FIGURE. In the FIGURES:

FIG. 1 is a schematic block diagram of an environmental control system.

### DETAILED DESCRIPTION

Aspects of the present disclosure are directed to systems and methods suitable for use in a vehicle to detect and/or receive information regarding vehicle operating conditions and operator conditions. The systems and methods analyze the vehicle operation and the condition of the operator to determine whether the operator may be exhibiting risky behavior due to mood or fatigue, and make adjustments to lighting, temperature, and/or audio playback in response thereto.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, right and left, top and bottom, upper and lower, and vertical and horizontal are intended for convenience of description, not to limit the present systems and methods or their components to any one positional or spatial orientation.

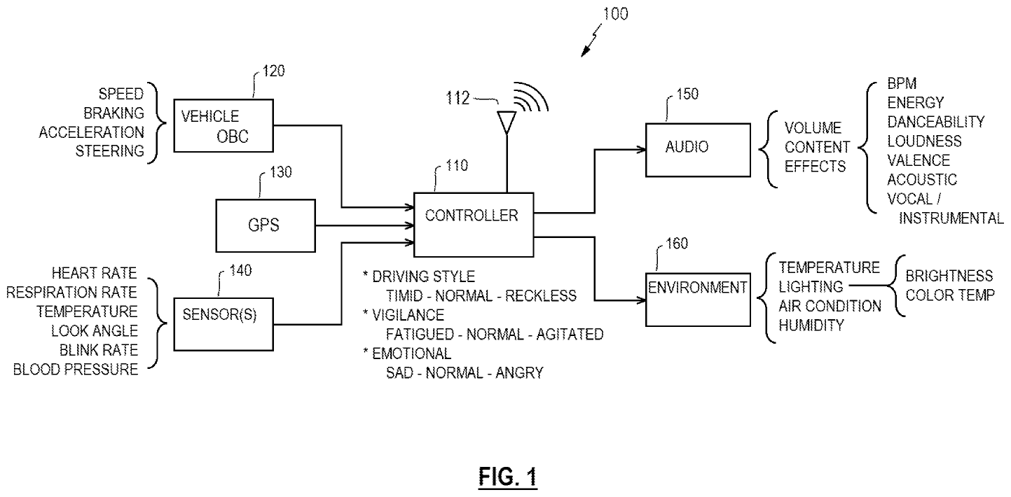

FIG. 1 illustrates an example system 100 including a controller 110 that receives various information, evaluates a state of operation of a vehicle and/or operator of the vehicle, and may adjust aspects of the vehicle cabin in response to the state of operation of the vehicle and/or the operator. In various examples, the controller 110 may receive information about the vehicle from a vehicle on-board computer (OBC) 120, such as via a controller area network or bus that reports information about the vehicle. In some examples, the controller 110 may receive information about location of the vehicle, such as from a Global Positioning System (GPS) 130 or navigation system. In certain examples the controller 110 may receive information about the operator of the vehicle from various sensors 140. In response to the information received, the controller 110 may assess or characterize a state of the operator and/or a state of the operation of the vehicle. Based upon the state of the operator and/or the state of operation of the vehicle, the controller 110 may adjust an output of an audio system 150 and/or other environmental controls 160.

In various examples, the controller 110 may be a controller associated with the vehicle, such as a computing system installed in the vehicle or coupled to or part of the OBC 120. In other examples, the controller 110 may be a separate computing system, and may be a portable device such as a mobile tablet or phone. In some examples, the controller 110 may be coupled to the OBC 120 via a wireless interface, such as a Bluetooth or Wi-Fi interface to an On-Board Diagnostics (OBD) system connected to a vehicle OBD connector. In other examples, the controller 110 may be wired to the OBC 120 via a cable and/or may be integrally connected as part of an installed system in the vehicle.

In various examples, the controller 110 may be coupled to a GPS 130. In some examples, the GPS 130 may be part of a navigation system installed in the vehicle. In some examples, the GPS 130 may be integral to the controller 110, such as a controller 110 that is a smart phone and includes a GPS 130. In various examples, the GPS 130 can provide information about the location of the vehicle and/or speed of the vehicle and/or direction of travel. Additionally, using the location information, the controller 110 may retrieve information about speed limits and/or road conditions (e.g., weather, traffic, road work, etc.) from a database, which may be locally stored in some cases or may be accessible through a network interface 112, for instance. In some examples, the interface 112 may be a wireless interface such as a cellular interface.

In some examples, imaging sensors around the perimeter of the vehicle (e.g., from mobile device camera(s) and/or vehicular camera(s)) may be processed to determine, for example, the posted speed limit, local traffic, weather, lighting conditions, road conditions, etc.

In some examples, information about the operational condition of the vehicle—beyond speed—may be determined from GPS 130 or location information. For instance, hard braking and/or acceleration can be determined from changes in speed or location. Steering control of the vehicle may be determined from changes in direction of the vehicle.

In some examples, information about the operational condition of the vehicle may be determined from other sensors, e.g., not from an OBC 120. For instance, an accelerometer may be used to determine acceleration, braking, and steering information.

In some examples, time of day information may be used by the controller 110 to assess a state of the operator and/or operation of the vehicle. For example, an operator is more likely to be fatigued or drowsy at night.

In various examples, the controller 110 may be coupled to one or more sensors 140 for determining information about a state of the operator of the vehicle. Examples of sensors 140 may include cameras, depth or distance sensors, and/or wearable devices. For example, a heart rate monitor, blood oxygen sensor, thermometer, and/or blood pressure sensor are examples of some wearable devices that may sense one or more conditions of the operator. In some examples, a video camera may provide images of the operator, which may include infrared and/or distance information at portions of the image(s). Accordingly, a camera type of sensor 140 may provide image (including video) information from which various operator conditions may be determined. For example, an angle and look-direction of the operator's head may be determined from image data. Eye look location and/or status as open or closed (or partially open) may be determined from image data. Eye blink rate can therefore be determined from a series of images or video. Additionally, breathing and respiration rate may be determined from sequential images or video. In some examples, heart rate may be determinable from image or video data. In some example, advanced sensors 140 may provide information from which blood oxygen level and/or blood pressure may be determined at a distance without being in contact with the operator's skin.

In some examples, the controller 110 may be a computer application (app) running on a mobile device, such as a smart phone. In some such instances, the mobile device may include one or more of a GPS, accelerometer(s), compass, and/or camera from which the various example information described herein may be received and/or determined. A display and/or user input devices may be associated with the controller 110 in some examples. For instance, the controller may display a user interface and/or information about its operation on a hardware display.

In some examples, a mobile device application (e.g., Android, iOS) may work with various audio streaming applications, such as Spotify, Pandora, etc., some of which may, for instance, provide access to API's and SDK's to interface with the streaming application.

At least one example may retrieve a playlist of music familiar to the user, a default ambient lighting choice, and/or a default ambient temperature preference, and may initiate playing music from the list, setting the lighting, and/or setting the vehicle cabin temperature.

In various examples, the controller 110 may evaluate or process any of the information described to determine an estimation for the emotional and physical state of the operator, and/or to assess the operator's driving style and/or vigilance level, based on a Generalized Additive Model (GAM), such as a weighted addition of various measurable numerical parameters, any of which may be normalized and/or inversed. In some examples, the controller 110 may evaluate or process any of the information described to determine an estimation for the emotional and physical state of the operator, and/or to assess the operator's driving style and/or vigilance level, based on an artificial intelligence (AI) model, such as via a neural network.

In some examples, the estimated state of the operator may be displayed, such as in a graphical user interface (GUI), for example on a three-color-zone meter by the app. For instance, sad or fatigued may be indicated by a blue zone, a normal, alert, relaxed, or happy state may be indicated by a green zone, while an angry, upset, irritated, or agitated state may be indicated by a red zone. Of course, the colors described are merely examples of a particular assignment of colors, and number of colors. If the estimated state of the operator is inaccurate, the controller 110 may allow the operator/user to correct the assessment by selecting what he or she feels is the correct zone, which may cause an update to weighting coefficients of the GAM.

Based on the zone of the operator, the controller 110 may select the best audio condition (e.g., music), ambient light, and/or temperature to encourage the operator's state to transition to the green zone. With respect to audio condition, any of audio volume, content, or other audio effects, such as perceived sound stage or virtualization, may be adjusted. For example, music choice may be based on the following set of attributes:

1. Beats Per Minute (BPM)—The tempo of the song.

2. Energy—The energy of a song—the higher the value, the more energetic song

3. Danceability—The higher the value, the easier it is to dance to this song.

4. Loudness—The higher the value, the louder the song.

5. Valence—The higher the value, the more positive mood for the song.

6. Acoustic—The higher the value the more acoustic the song is.

7. Vocal/Instrumental—whether there are vocals/lyrics to the song

The controller 110 may continuously monitor the user/operator's state to determine the effectiveness of the choice of music, light, and/or temperature, and may update a database accordingly for future use with the same operator or a general population, which may be based upon various demographics, such as gender, age, race, education, social class, income, etc.

In some examples, the controller 110 may analyze the received information described herein to assess the operator's driving style and/or vigilance level.

In some examples, a driving style may be assessed as acceptable or risky. In some examples the driving style may be assessed as one of being timid, normal, or reckless. In various examples, an assessed driving style may be assigned based upon any number of levels (e.g. beyond three) or on a continuum. In certain examples, the assessed driving style may be assigned a number or score.

In some examples, a vigilance level may be assessed as acceptable or risky. In certain examples the vigilance level may be assessed as one of being fatigued, normal, or agitated. In various examples, an assessed vigilance level may be assigned based upon any number of levels (e.g. beyond three) or on a continuum. In certain examples, the assessed vigilance level may be assigned a number or score.

As described above with respect to emotional and physical state of the operator, the controller 110 may evaluate or process any of the information described to assess the driving style and/or vigilance level of the operator based on a GAM.

As described above with respect to emotional and physical state of the operator, an assessed driving style and/or vigilance level may be displayed, such as in a GUI, for example on a three-color-zone meter. In some examples, the controller 110 may determine an assessed driving style and/or vigilance level based upon objective measurable parameters of the operation of the vehicle, and/or statistics of the same, without regard for any assessment of the driver and/or without regard for any biometric information about the driver.

In some examples, the controller 110 may adjust the color temperature in the vehicle based upon the assessed driving style and/or vigilance level. In some instances, warmer (e.g., more yellow, soft) light may be selected to relax a reckless or agitated operator. On the other hand, cooler light (e.g., more blue, harsh) may act to wake up a fatigued driver and/or boost confidence of a timid driver. In certain examples, when an assessed driving style or vigilance level is acceptable, which may be assessed as normal, the lighting color may be set to a user-defined default.

In response to an assessment of timid or fatigued, in some examples the controller 110 may adjust color temperature into a range of 5,000 to 10,000 Kelvin. In some examples, the controller 110 may adjust color temperature into a range of 6,000 to 8,000 Kelvin. In some examples, the controller 110 may adjust color temperature into a range of about 7,000 Kelvin.

In response to an assessment of agitated or reckless, in some examples the controller 110 may adjust color temperature into a range of 1,900 to 3,200 Kelvin. In some examples, the controller 110 may adjust color temperature into a range of 2,200 to 2,800 Kelvin. In some examples, the controller 110 may adjust color temperature into a range of about 2,600 Kelvin.

In various examples, the controller 110 may adjust the ambient temperature in response to an assessed driving style and/or vigilance level. Studies show that high temperatures tend to lead to more risk-prone behaviors.

In some examples, the controller 110 may respond to an assessed driving style of reckless by adjusting the ambient temperature to drop, as much as four degrees Centigrade in some examples. In various examples, the controller 110 may adjust the temperature to drop in intervals. In some examples, the intervals may drop temperature about one degree per minute.

In some examples, the controller 110 may respond to an assessed driving style of timid by adjusting the ambient temperature to increase, as much as seven degrees Centigrade in some examples. In various examples, the controller 110 may adjust the temperature to increase in intervals. In some examples, the intervals may increase temperature about one degree per minute.

In some examples, in response to an assessed vigilance level of fatigued, the controller 110 may adjust ambient temperature to drop, while assessments of agitated may also adjust ambient temperature to drop, both by as much as four degrees Centigrade in some examples. In various examples, the controller 110 may adjust the temperature to drop in intervals. In some examples, the intervals may drop temperature about one degree per minute.

When there is a conflict between desired settings for driving style and vigilance level, in certain examples, reckless settings take priority over all others, then agitated, then fatigued. This may be desirable because reckless driving causes the highest level of risk, etc.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A method of controlling an environment of a vehicle, the method comprising:
receiving information about a characteristic of at least one of the vehicle's operation, the vehicle's location, and an operator of the vehicle;
analyzing the information using a generalized additive model to assess a driving condition; and
adjusting an environmental setting of the vehicle based upon the assessed driving condition.

2. The method of claim 1 wherein information about a characteristic of the vehicle's operation includes one or more of speed, braking, and steering.

3. The method of claim 1 wherein information about a characteristic of the operator of the vehicle includes biological information from a sensor.

4. The method of claim 3 wherein the biological information includes one or more of heart rate, temperature, respiration rate, and blood pressure.

5. The method of claim 1 further comprising receiving and processing image information from a camera.

6. The method of claim 5 wherein processing image information includes determining the information about a characteristic of the operator.

7. The method of claim 1 wherein the information about a characteristic of the operator includes one or more of heart rate, temperature, respiration rate, look direction, blink rate, and blood pressure.

8. The method of claim 1 wherein assessing a driving condition includes assessing at least one of a driving style of the operator, vigilance of the operator, and an emotional state of the operator.

9. The method of claim 1 wherein the environmental setting includes one or more of an audio volume, an audio content, an audio perception, a temperature setting, a lighting brightness, a lighting color temperature, an air conditioning setting, and a humidity control.

10. A vehicle comprising:
a plurality of sensors for detecting information about a characteristic of at least one of the vehicle's operation, the vehicle's location, and an operator of the vehicle;
a controller coupled to the plurality of sensors and configured to receive and analyze the information using a generalized additive model to assess a driving condition; and
one or more environmental controls coupled to the controller, the controller further configured to adjust an environmental setting of the vehicle based upon the assessed driving condition.

11. The vehicle of claim 10 wherein information about a characteristic of the vehicle's operation includes one or more of speed, braking, and steering.

12. The vehicle of claim 10 wherein information about a characteristic of the operator of the vehicle includes biological information from a sensor.

13. The vehicle of claim 12 wherein the biological information includes one or more of heart rate, temperature, respiration rate, and blood pressure.

14. The vehicle of claim 10 wherein the controller is further configured to receive and process image information from a camera.

15. The vehicle of claim 14 wherein the controller is further configured to process the image information to determine the characteristic of the operator.

16. The vehicle of claim 10 wherein the information about a characteristic of the operator includes one or more of heart rate, temperature, respiration rate, look direction, blink rate, and blood pressure.

17. The vehicle of claim 10 wherein assessing a driving condition includes assessing at least one of a driving style of the operator, vigilance of the operator, and an emotional state of the operator.

18. The vehicle of claim 10 wherein the environmental setting includes one or more of an audio volume, an audio content, an audio perception, a temperature setting, a lighting brightness, a lighting color temperature, an air conditioning setting, and a humidity control.

19. A non-transitory computer readable medium having instructions encoded thereon that, when executed by a suitable processor, cause the processor to perform a method comprising:
receiving information about a characteristic of at least one of a vehicle's operation, the vehicle's location, and an operator of the vehicle;
analyzing the information using a generalized additive model to assess a driving condition; and
adjusting an environmental setting of the vehicle based upon the assessed driving condition.

20. The medium of claim 19 wherein assessing a driving condition includes assessing at least one of a driving style of the operator, vigilance of the operator, and an emotional state of the operator.
